(19) United States
(12) Patent Application Publication
(10) Pub. No.: US 2006/0062626 A1
(43) Pub. Date: Mar. 23, 2006

(54) Keypad ergonomics

(75) Inventors: Alistair Hamilton, Stony Brook, NY (US); Sudhir Bhatia, Brooklyn, NY (US); Vanessa Rimando, Forest Hills, NY (US); Richard Hanks, Swansea, MA (US)

Correspondence Address: AMIN & TUROCY, LLP, 1900 EAST 9TH STREET, NATIONAL CITY CENTER, 24TH FLOOR,, CLEVELAND, OH, 44114, US

(73) Assignee: Symbol Technologies, Inc., Holtsville, NY (US)

(21) Appl. No.: 10/946,884

(22) Filed: Sep. 22, 2004

(51) Int. Cl. B41J 5/12

(52) U.S. Cl. 400/490

(57) ABSTRACT

Systems and methodologies are provided for improving dynamics of striking a key on a keypad during operation thereof, by shifting contours (e.g., slope of a key's surface plane) on surface of a key, based on location of that key on the keypad, and a manner (e.g., the finger used) the key is being stroked. Accordingly, the subject invention can employ varying surface contours to optimize contact between a user's finger and the key at any point depending on predetermined geometric locus for the movement of a user's hand and/or fingers when employing the keypad. A wave key and a pillowed key arrangement are disclosed according to exemplary aspects of the invention. Moreover, a raised protrusion (“ski jump feature”) can be provided around edges of keypad to enhance grip capabilities for the key pad and/or the host device.

### TECHNICAL FIELD

The subject invention relates generally to key pad structures, and more particularly to systems and methods for sculpting shape of key members to enhance a manner and dynamics of striking keys on a key pad, during operation by a user.

### BACKGROUND OF THE INVENTION

In recent years, the demand for access to computing power, coupled with the significant decrease in computer size has yielded portable electronics devices, such as handheld computers, which enable users to carry computing resources that previously were limited to relatively fixed, desktop computers. In particular, special-purpose computing and communication devices have been developed, including digital personal assistants, cellular phones, global positioning system receivers, and any number of other electronics devices. Such portable hand held terminals users produce and manage large amounts of data or information, as compared to their respective work load in prior years. Accordingly, portable hand held terminals are employed in many different industries, and are typically assembled by enclosing internal electrical components; such as keypads, a central processing unit (CPU) board, display, and internal wiring, within a housing made of plastic or another structural material.

Generally, a desirable characteristic of such terminals is that they can readily function, while a respective user performs other more demanding tasks. For example, a user may find it necessary to operate a data terminal with one hand, while leaving the other hand free. In particular, the user may find it desirable to lift or otherwise shift small items of inventory with one hand, while simultaneously inputting data or scanning them with the portable scanner held in the other hand.

Moreover, when employing the keypad for data input, the user typically should be able to manipulate keys on the keypad with ease and accuracy. Otherwise, the ensuing incompatibility can cause the hand, finger and wrist movements of the user operator to be somewhat strained, slowed, and even sometimes misdirected, resulting in not only unwanted and undesired physical stress on the operator, but also in undesired fatigue with resulting entry errors. The results of such repetitive stress and errors while manipulating the keypad on a portable terminal can cause unwanted loss in time for correcting the errors, as well as a loss in productivity through stress related injuries suffered by the keyboard operator. Such injuries may be severe enough to render the individual unemployable. For example, repetitive stroking of an incompatible keypad can typically stress the wrists, elbows and shoulders of an operator. As stated earlier, when continued over long periods of time, this can lead to repetitive stress injuries, such as carpal tunnel syndrome, which is a painful and oftentimes a crippling ailment affecting the tendons and nerves in the user's wrist area. Moreover, carpal tunnel syndrome is only one of several musculoskeletal injuries, frequently being identified variously as cumulative trauma disorder, repetitive strain injury, as well as repetitive motion disorder.

At the same time there is a continuing desire to reduce size of portable units. Such reduction in size can reduce the space available to the keypad and the associated individual key members. This can further hinder rapid and accurate data manipulation on a keypad interface. In particular, the user/operator should be able to enter information easily, rapidly and accurately, and typically should not be required to undergo extensive and time consuming training in order to use the keypad arrangement for rapid data entry.

Therefore, there is a need to overcome the aforementioned deficiencies associated with conventional devices.

### SUMMARY OF THE INVENTION

The following presents a simplified summary of the invention in order to provide a basic understanding of one or more aspects of the invention. This summary is not an extensive overview of the invention. It is intended to neither identify key or critical elements of the invention, nor to delineate the scope of the subject invention. Rather, the sole purpose of this summary is to present some concepts of the invention in a simplified form as a prelude to the more detailed description that is presented hereinafter.

The subject invention provides for systems and methods of improving dynamics of striking a key on a keypad during an operation thereof, by shifting contours (e.g., slope of a key's surface plane, surface configuration, and the like) on surface of a key, based on location of that key relative to the motion and/or geometric locus of the striking finger, and a manner (e.g., the finger used) the key is being stroked. For example, should a user's thumb be primarily employed for striking keys on a key pad of a portable terminal then, during keying operation, the thumb motion can typically sweep an arc across a surface of the key pad, with the angle of contact for the thumb and a key varying based on the position of the key on such arc. Thus, for such thumb motion, in accordance to an exemplary aspect of the subject invention a range of surface contours can be provided, wherein at one end the surface contours are parallel to a plane swept by the arc motion of the thumb, and at another end such surface contours are substantially perpendicular to the plane of the thumb's arc motion.

Accordingly, the subject invention can employ varying surface contours to maximize contact between a user's finger and the key at any point depending on the movement of the user's hand and/or fingers when employing the keypad. Thus, as a user's finger (e.g., a thumb) moves to different positions on the keypad, the subject invention facilitates maximizing a contact surface area exposed for striking the key, via shifting contours on surface of the keys.

In a methodology according to one aspect of the subject invention, motion of a user's finger on the keypad can be initially determined, and a geometric locus of such motion established for a particular application and/or portable device. Next, the surface contour of each key can be varied based on a key's respective location on the geometric locus, to provide for a contact force substantially perpendicular (as opposed to an obtuse angle) to surface of a key, during access thereof. For example, a user's thumb can typically follow an arc during selection of individual keys on a keypad, and a wave shaped contour can be formed on the surface of the keys being positioned on the arc, so that as a user's thumb moves to different positions on the keypad, a contact surface area exposed to user's thumb is optimized.

In a related aspect of the subject invention, a tactile bump can be provided as part of a key. The location of such tactile feature on a key (or as it changes from one key to another key) can supply a cognitive correspondence to functions of a device (e.g., a tactile feature can correspond to the direction that a cursor can move on a display). For example, if a user's thumb is moved down form a home key to a lower positioned key, a bump can be felt on the lower portion thereof, which can signify to a user that pressing such key can move a cursor down on a display screen, of the unit hosting such keypad arrangement. Accordingly, an operation (e.g., cursor navigation) for the host unit can be improved via facilitating a typically blind keying of the keypad. Moreover, a surface of the key can be sculpted with various features to provide a unique tactile feel to correspond to a function of the host unit, wherein such tactile features can be memorized by the user.

According to a further aspect of the invention, surface of a key can be raised around the edges as to create a well compartment or recessed area in a middle portion of the key (pillowed key), to distribute an actuating force exerted on the key across a surface area of the recessed portion. In addition, a raised protrusion (“ski jump feature”) can be provided around edges of keypad to enhance grip capabilities for the key pad and/or the host device, when a user primarily employs thumbs for keying and the middle/index fingers for holding the keypad. Such raised protrusion can extend from the surface of the keypad and substantially elongated sideways thereto, with a typically curved inside surface.

To the accomplishment of the foregoing and related ends, the invention, then, comprises the features hereinafter fully described. The following description and the annexed drawings set forth in detail certain illustrative aspects of the invention. However, these aspects are indicative of but a few of the various ways in which the principles of the invention may be employed. Other aspects, advantages and novel features of the invention will become apparent from the following detailed description of the invention when considered in conjunction with the drawings. To facilitate the reading of the drawings, some of the drawings may not have been drawn to scale from one figure to another or within a given figure.

### BRIEF DESCRIPTION OF THE DRAWINGS

FIGS. 1 (a) thru 1(c) illustrate an exemplary shifting contour in the form of a changing slope and wave shaped contour on a key's surface plane according to a particular aspect of the subject invention.

FIGS. 2(a) and 2(b) illustrate another exemplary shifting contour with a pillowed key arrangement according to another aspect of the subject invention.

FIG. 3 illustrates a tactile bump arrangement according to one particular aspect of the subject invention.

FIG. 4 illustrates an exemplary methodology according to one aspect of the subject invention.

FIGS. 5(a) and 5(b) illustrate a perspective and cross sectional view of a key pad with a grip enhancement feature in accordance with an aspect of the subject invention.

FIG. 6 illustrates an exemplary stack of keypad components employed for fabricating a keypad with varying concave/convex/sloped surface contours in accordance with an aspect of the subject invention.

FIG. 7 illustrates another hand held terminal with a grip enhancement feature in accordance with an aspect of the invention.

FIG. 8 illustrates an exemplary hand held scanner that can host a keypad with shifting contours in accordance with an aspect of the subject invention.

FIG. 9 illustrates a general block lay out of a device employing the invention.

### DETAILED DESCRIPTION OF THE INVENTION

The subject invention is now described with reference to the drawings, wherein like reference numerals are used to refer to like elements throughout. In the following description, for purposes of explanation, numerous specific details are set forth in order to provide a thorough understanding of the subject invention. It may be evident, however, that the subject invention may be practiced without these specific details. In other instances, well-known structures and devices are shown in block diagram form in order to facilitate describing the subject invention.

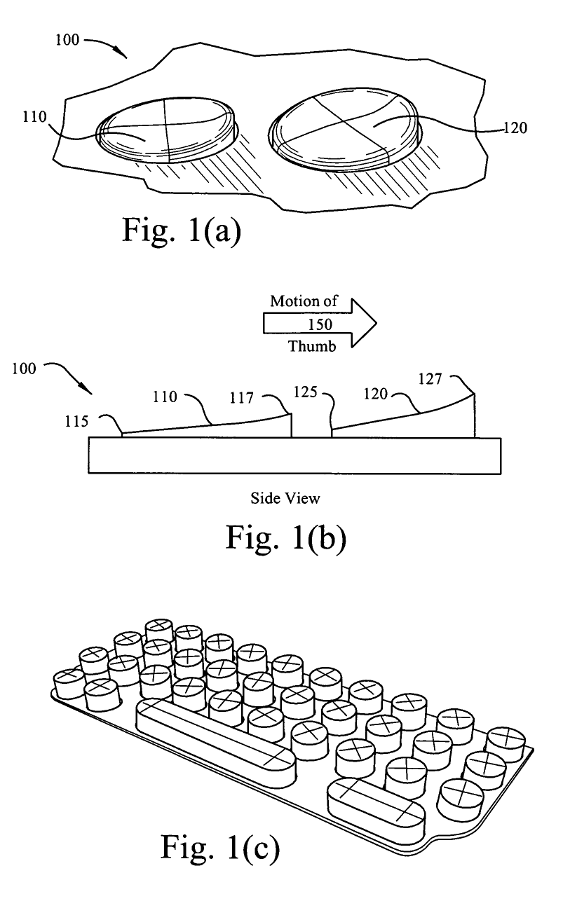

The subject invention provides for systems and methods for facilitating striking a key on a keypad, by employing a surface contour that varies from one key to another key, to optimize a contact surface area during an access of the keys. Referring initially to FIG. 1(a), a perspective view of keys having a wave shaped contour is illustrated. In accordance with an aspect of the subject invention, the keys 110 and 120 can be part of a key pad for a portable terminal, which in contrast to standard keyboards that essentially do not frequently utilize the thumb (for example, only to operate a space bar), can fully utilizes the left and right thumbs for its operation. In general, the thumbs can be considered the most fully articulated digits on the human hand, and consequently, the keyboard of the subject invention can use each thumb to control a plurality of keys and the associated functions. Such can significantly expand the potential capabilities of the keyboard while employing each of the fingers for five basic movements, namely, away from the body, toward the body, left, and right. Each of the keys 110 and 120 can have a lowered portion 115, 125 and a heightened portion 117, 127, as illustrated in FIG. 1(b). In accordance with an aspect of the subject invention, such topology and configuration of the keys 110 and 120 surface area can be based on the geometric locus for the motion of a finger that is primarily employed for using such keys, to induce a contact force substantially perpendicular to the key.

For example, a user's thumb can typically follow an arc motion during selection of individual keys on a keypad, as illustrated by arrow 150 in the cross sectional view of FIG. 1(b). Accordingly, as the thumb moves farther away from its starting point on such arc to different positions, the surface contour of the keys can be varied based on a key's respective location on the geometric locus for the thumb motion, to provide for a contact force substantially perpendicular (as opposed to an obtuse angle) to surface of a key, during access thereof. FIG. 1 (c) illustrates a perspective view of a keypad with wave configurations. When a user employs such a keypad, problems with accidental keying can be mitigated, as a user can readily differentiate contact points for different keys during movement of finger(s) (for example, an arc shaped movement of the thumb.) It is to be appreciated that the system and methods of subject invention are not limited to a key's contour variance for the thumb of a user, and can be also employed for other fingers, once a respective geometric locus has been established for such fingers while employing a particular application and/or mobile terminal.

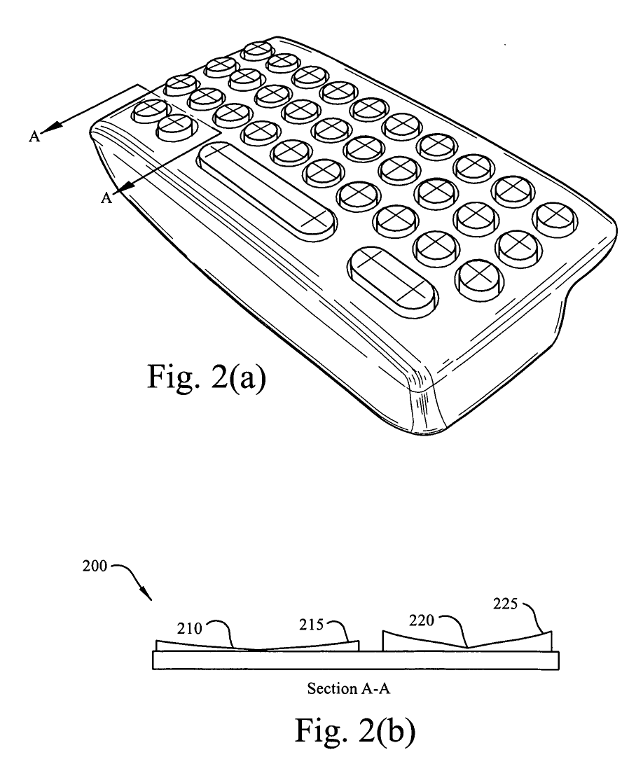

FIGS. 2(a) and 2(b) illustrate another exemplary shifting contour with a “pillowed key” configuration 200 in accordance with an aspect of the subject invention. Such pillowed key configuration 200 has a recessed central portion 210, 220 designed, with raised portions 215, 225 around the edges of individual key member(s), to create an optimized contact surface with the user's fingers. As such an actuating force exerted on the key can be distributed across a larger surface area of the finger, as compared to a key having a flat surface. The recess 210, 220 can be in a form of concave surfaces; combination of various curve features, lines and the like. Moreover, to enable a user to readily distinguish various individual keys, rows and/or columns of the keypad arrangement can include flat surfaces, while other keys, rows and/or columns can include curved features. For example, according to one particular aspect of the subject invention for a QWERTY key pad, the top three rows can be shaped with various curved configuration, while the fourth and bottom row can be shaped with flat top keys, thus allowing for a tactile differentiation with other rows. Such tactile differentiation can also be employed to correspond to the various functions, being performed by the terminal hosting a keypad of the subject invention.

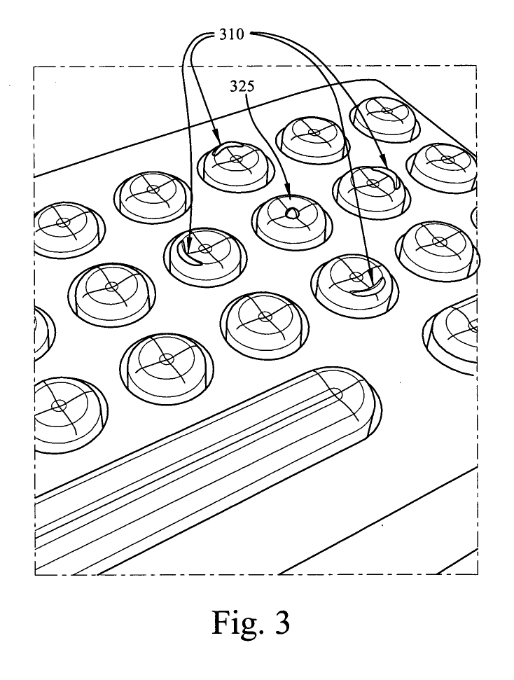

Referring now to FIG. 3, a tactile bump in the form of a raised protrusion 310 on a plurality of keys surrounding a home key 315 is illustrated. Each raised protrusion 310 can be placed at an edge relative to the center of a respective key, and supply a cognitive correspondence to functions of a device, e.g., a tactile feature can correspond to the direction that a cursor can move on a display of the host unit device. For example, initially the thumb can be placed on the home key 325. Next, movement of the thumb to the right can cause a contact with the bump located on a right portion of the adjacent key. This can signify to a user that pressing such key can perform a function, which can be correlated to the placement of the bump, such as moving a cursor on the screen to the right. Accordingly, an operation for the host unit can be improved via mitigating a typically blind keying of the keypad. Likewise, tactile protrusions can be provided on other keys in the vicinity of the home key to provide a user with similar cognitive correspondence to other functions of a device.

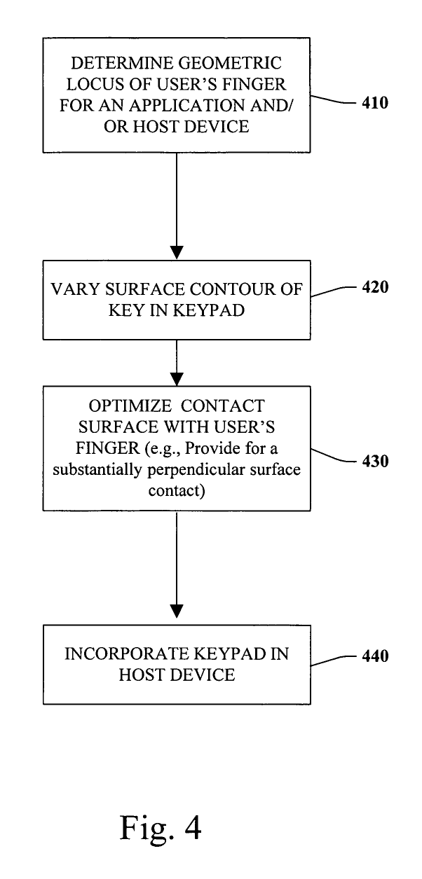

FIG. 4 illustrates a methodology according to one aspect of the subject invention. Initially, and at 410 a determination can be made for a motion of a user's fingers for operation of the mobile terminal, and/or specific application loaded thereon. For example, a particular application can require that a user constantly move the right hand thumb among a plurality of keys. Such motion can provide for an arc shaped movement forming the geometric locus of the thumb pad for the user. Next, and at 420 the surface contour of each key positioned in such geometric locus can be varied, as discussed in detail supra, to provide for a contact force substantially perpendicular (as opposed to an obtuse angle) to surface of a key, during access thereof. For example, a user's thumb can typically follow an arc during selection of individual keys on a keypad. As such, a wave shaped contour can be formed on the surface of the keys being positioned on the arc, so that as a user's thumb moves to different positions on the keypad, a contact surface area exposed to user's thumb is optimized, at 430. For example, a range of surface contours can be provided on a plurality of keys on the keypad, such that at one end, the key's surface is being parallel to a plane swept by the arc motion of the thumb, and at another end surface contours that are substantially perpendicular to the plane of such arc motion. The keypad can then be placed in the host device with the required application uploaded to be employed by the user, at 440.

While the exemplary method is illustrated and described herein as a series of blocks representative of various events and/or acts, the subject invention is not limited by the illustrated ordering of such blocks. For instance, some acts or events may occur in different orders and/or concurrently with other acts or events, apart from the ordering illustrated herein, in accordance with the invention. In addition, not all illustrated blocks, events or acts, may be required to implement a methodology in accordance with the subject invention. Moreover, it will be appreciated that the exemplary method and other methods according to the invention can be implemented in association with the method illustrated and described herein, as well as in association with other systems and apparatus not illustrated or described.

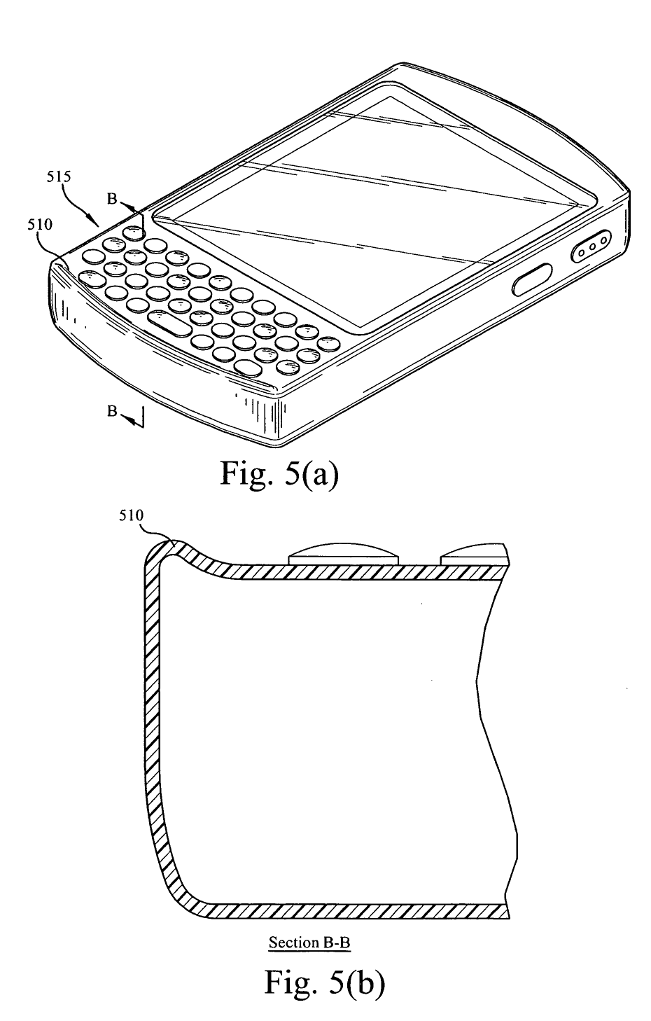

FIGS. 5(a) and 5(b) illustrate a perspective view and cross sectional view of a keypad in accordance with the subject invention, wherein a raised protrusion can be provided around an edge(s) of keypad to enhance grip capabilities for the key pad and/or the host device when, for example, a user primarily employs thumbs for keying and the middle/index fingers for holding the keypad. Such raised protrusion 510 can extend from the surface of the keypad 515 and substantially elongated sideways thereto, with a typically curved inside surface to form of a ski jump attribute as part of the raised protrusion 510. The raised protrusion 510 can be integral molded with the keypad or attached thereto after fabrication of the keypad, and can also provide for a rest area for a user's finger(s) or hand. It is to be appreciated that the function of the raised protrusion 510 is not so limited and other functions such as; acting as an external bumper system to protect the face of the keypad from an external impact and/or shock can be performed thereby. Accordingly, various cushion members in the form of resilient or rubber-like pads can be included as part of the raised protrusion feature 510.

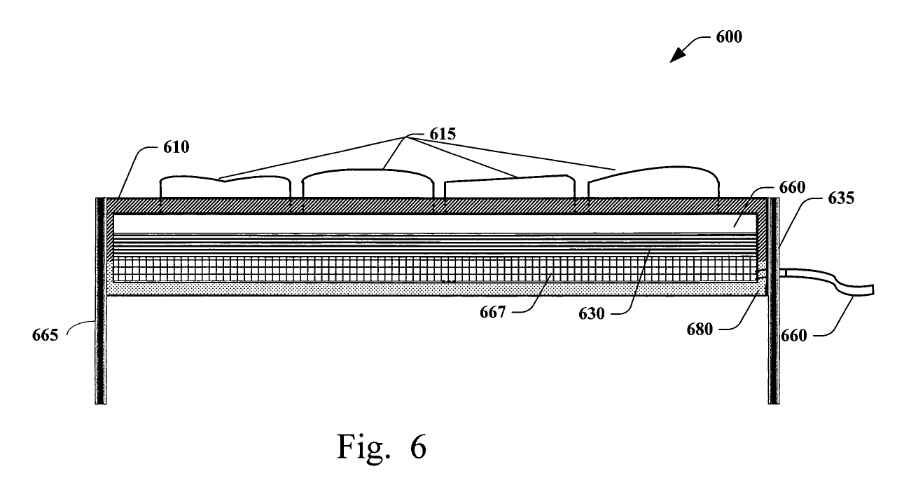

FIG. 6 illustrates an exemplary stack of keypad components employed for fabricating a stand alone keypad 600 with varying contours based on location of that key on the keypad, and a manner (e.g., the finger used) that the key is being stroked. Such stack can be packed or sandwiched between a top cover 610 and a bottom cover 680 that are over molded alongside a common boundary (665, 635) to create a sealed keypad assembly unit 600. The packed stack can include a silicone membrane 660 placed on top of an electro luminous panel 630, which in turn overlies a printed circuit board 667 with a flex member 660 hanging over sides thereof. The silicone membrane 660 can contain the individual keys 615 positioned thereupon, which protrude out of the top cover 610 via orifices therein, and can exhibit various contour features based on location of that key on the keypad, and a manner (e.g., the finger used) the key is being stroked. Each key 615 can have a concave/convex/slanted upper surface relative to its application to optimize a contact surface area exposed to a user's finger, wherein the individual keys are sufficiently spaced apart so as not to interfere with actuating any one key. Entering variable data via the keypad to a host unit is similar to operating a calculator.

In addition dome shaped switch projections (not shown) are positioned at the bottom portion of each key, and are displaced between individual keys and the printed circuit board 667. When assembled, the contact projection of a corresponding dome switch at the bottom of each key aligns with a designated contact point (not shown) on the printed circuit board 667. When a key is pressed, its corresponding dome switch actually touches the designated contact point on the printed circuit board 667 to complete an electrical circuit, and generate an input signal. When the user releases a pressure on the key, the dome switch and key restore to their original positions. The dome switches are selected from a material having a predetermined degree of elasticity such that the dome switches can return to their original shape after the user withdraws from pressing on the keys. The electro luminous panel 630 can be a thin plastic component that can glow when a current is applied thereto, and is positioned beneath the silicone membrane 660.

As illustrated, the top cover 610 and bottom cover 680 can define a common perimeter extending around the keypad assembly, which can be subsequently over molded (665, 635) to create a sealed keypad assembly unit 600. The packed stack between the top cover 610 and the bottom cover 680 can include: a printed circuit board 667 with a flex member 660 that can be an extension thereof, an electro luminous panel 630, and a silicone membrane with a plurality of keys thereupon. The top cover 610 can include a plurality of orifices wherein the keys 615 poke there through. The printed circuit board 667 can be connected to an inner surface of the bottom plastic cover 680 via an adhesive, or can also be insert molded therein. The projecting flex member 660 can bend and attach to an outer surface (facing the host unit) of the bottom cover 680, to operatively connect the host unit.

It will be appreciated by one skilled in the art that a variety of different wire patterns and metal strips can be selected in order to achieve the desired connections with the host device. Also, conducting metal lines on such flex member 660 can be formed by printing, etching, or any other suitable method. The varying contour keypad of the subject invention can be employed in a variety of electrical or electronic device that can require entry of a user's input via pressing alpha, alphanumerical designations or keys thereon. Examples of such devices can include, palm pilots, mobile phones, telephones, faxes, computers, mini computers, scanners, terminals, and the like.

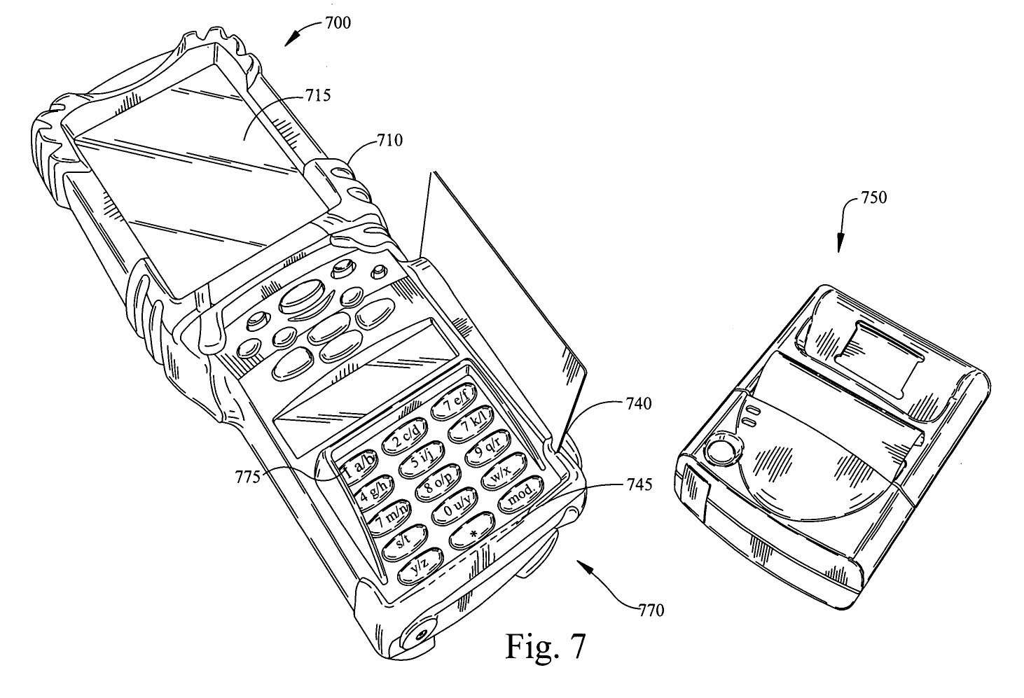

One particular device that can incorporate such keypad is a handheld terminal 700 of FIG. 7 that includes a keypad 770 employing a varying surface and a raised grip protrusion 745 (ski jump feature) in accordance with an aspect of the subject invention. In particular, when a user primarily employs thumbs for keying and the middle/index fingers for holding the keypad, the raised grip protrusion 745 facilitates holding the keypad/host device in a secure position. The handheld terminal 700 includes a housing 710 which can be constructed from a high strength plastic, metal, or any other suitable material. The portable terminal 700 can also include a display 715 functions to display data or other information relating to ordinary operation of the handheld terminal 700 and/or mobile companion.

Additionally, the display 715 may display a variety of functions that are executable by the handheld terminal 700 and/or one or more mobile companion(s) 750. The display 715 can provide for a touch screen interface that can employ capacitive, resistive touch, infrared, surface acoustic wave, or grounded acoustic wave technology.

The handheld terminal 700 can also include a magnetic strip reader 740 or other data capture mechanism (not shown). The handheld terminal 700 can also include a window (not shown) in which a bar code reader/bar coding imager is able to read a bar code label, or the like, presented to the handheld terminal 700. The handheld terminal 700 can include a LED (not shown) that is illuminated to reflect whether the bar code has been properly or improperly read. Alternatively, or additionally, a sound may be emitted from a speaker (not shown) to alert the user that the bar code has been successfully imaged and decoded. The handheld terminal 700 also includes an antenna (not shown) for wireless communication with an RF access point; and an IR transceiver (not shown) for communication with an IR access point.

The keypad 770 can include a top cover and a bottom cover that can be over molded around a common boundary. In one aspect of the subject invention, the top cover and the bottom cover can sandwich a plurality of associated keypad components (e.g., flex members, electro luminous panel, a silicone membrane with a plurality of keys thereupon printed circuit boards, LEDs, and the like). The common boundary can be formed by a surface area and/or line perimeter common to the top cover and the bottom cover, (e.g. a contact surface between top and bottom cover, a surface encapsulating the keypad components, edges of the stacked components and the like.) Typically, materials employed for fabricating the keypad's 770 top cover and bottom cover can include various types of polycarbonates, thermoset plastics, thermoformed plastic, and typically material that are capable of over molding to provide a suitable bondage between the top cover and the bottom cover. Such suitable bondage can for example be capable of supplying a sealed keypad assembly that mitigates presence of external contaminants in the device. Moreover, the top cover can be fabricated with a transparent quality to provide for visual notification by illuminating a certain color or brightness on the keypad surface, when for example a particular key has been actuated.

Moreover, if during operation the user initiates a mode that assigns predetermined functions to specific keys, or changes a normal operation mode for the unit by pressing a predetermined key, then a portion of the keypad can illuminate via LED(s), as to alert a user of the selected mode of operation. By observing the illuminating color or brightness on the keypad surface, a user can readily ascertain the mode selected for the unit and prepare accordingly. In particular, when actuation of the key changes a keypad's standard alphanumerical designations that keypads are conventionally programmed for operation therewith. Accordingly, a user may be dumbfounded if not alerted to such alterations in the function of the keypad. To mitigate such ambiguity, the keypad 770 of the subject invention can provide a visual notification by illuminating a certain color or brightness on the keypad surface. Moreover, various audio heralds, alone or in combination with the visual alerts can be employed for alerting a user that a particular key has been actuated.

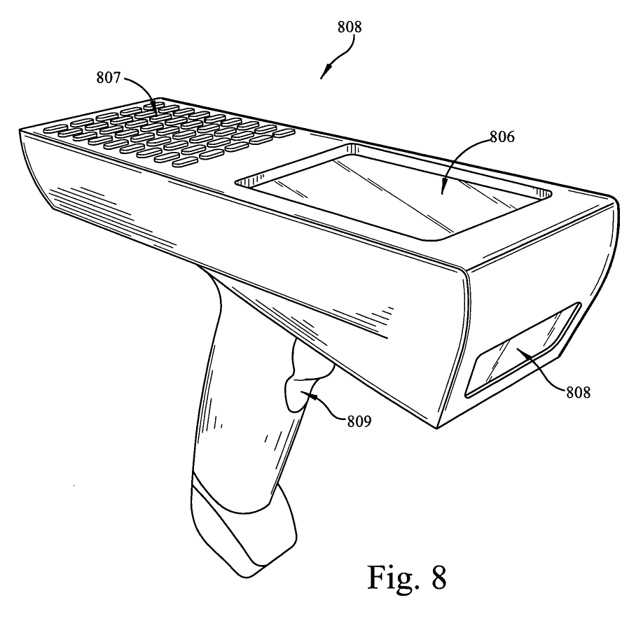

Referring now to FIG. 8, an exemplary hand held scanner is illustrated that can host a keypad with varying surface contours based on location of that key on the keypad, and a manner (e.g., the finger used) the key is being stroked. The host terminal 808 includes a display 806 for displaying information. The display 806 can be a touch screen and may employ capacitive, resistive touch, infrared, surface acoustic wave, or grounded acoustic wave technology. Furthermore, the display 806 can be a liquid crystal device, cathode ray tube (CRT), field emission device (FED, also called flat panel CRT) or any other display device suitable for creating graphic images and alphanumeric characters recognizable to the user. The host terminal 808 further includes a keypad 807, with varying surface contours as described in detail supra, which can be placed as a stand alone unit to enter information concerning modes of operation of the mobile terminal.

As shown, the portable bar code scanner 808 is configured to be held with the palm of a user's hand, and various keys on its keypad 807 can be engaged by thumb or fingers of the hand holding the housing. The user aims the window 808 at a desired indicia to be read and presses the trigger 809 that activates the reader unit. Display unit 806 can be employed to display information relating to a mode of operation of the electronic unit, or display check information relating to an item being read by an optical scanner (not shown) located in the electronic unit. The bar code scanner 808 can be employed in a wireless communication network for tracking inventory, storing data, etc. Typically, no cables can be required to connect the scanner apparatus to a computer device, thereby further reducing its weight and consequent fatigue, and eliminating the inefficiencies caused by entanglement with such cables. Moreover, its size allows easy access to difficult scanning locations. The scanner 808 provides rapid key entry and reading of displayed information, providing the operator with real time data so that decisions and actions can be quickly implemented. A user can input and/or process data via keypad, scanner element, etc. independent of the hand-held terminal 808 being connected to a communication network, for example a LAN or a WAN. When hand-held terminal 808 does not include a transceiver to provide for real time communications, the data can be stored in memory within the hand-held terminal 808. Accordingly, should the hand-held terminal 808 subsequently be connected to a network, stored data can be downloaded to a host computer (not shown).

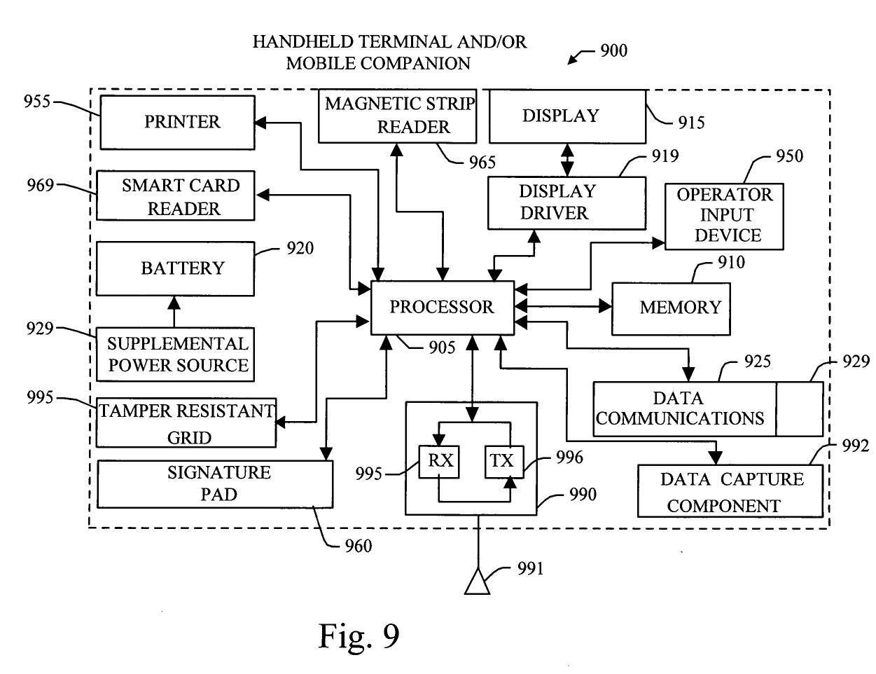

Turning now to FIG. 9, a schematic representation according to one aspect of the subject invention is shown in which a processor 905 is responsible for controlling the general operation of a handheld terminal and/or mobile companion 900. The processor 905 is programmed to control and operate the various components within the handheld terminal and/or mobile companion 900 in order to carry out the various functions described herein. The processor or CPU 905 can be any of a plurality of suitable processors. The manner in which the processor 905 can be programmed to carry out the functions relating to the subject invention will be readily apparent to those having ordinary skill in the art based on the description provided herein.

A memory 910 tied to the processor 905 is also included in the handheld terminal and/or mobile companion 900 and serves to store program code executed by the processor 905 for carrying out operating functions of the handheld terminal and/or mobile companion 900 as described herein. The memory 910 also serves as a storage medium for temporarily storing information such as user defined functions and the like. The memory 910 is adapted to store a complete set of the information to be displayed. According to one aspect, the memory 910 has sufficient capacity to store multiple sets of information, and the processor 905 could include a program for alternating or cycling between various sets of display information.

A display 915 is coupled to the processor 905 via a display driver system 919. The display 915 can be a liquid crystal display (LCD) or the like. The display 915 functions to display data or other information relating to ordinary operation of the handheld terminal and/or mobile companion 900. For example, the display 915 may display suggested configurations, which is displayed to the operator and may be transmitted over a system backbone (not shown).

Additionally, the display 915 may display a variety of functions that control the execution of the handheld terminal and/or mobile companion 900. The display 915 is capable of displaying both alphanumeric and graphical characters. Power is provided to the processor 905 and other components forming the handheld terminal and/or mobile companion 900 by at least one battery 920. In the event that the battery(s) 920 fails or becomes disconnected from handheld terminal and/or mobile companion 900, a supplemental power source 929 can be employed to provide power to the processor 905. The handheld terminal and/or mobile companion 900 may enter a minimum current draw of sleep mode upon detection of a battery failure.

The handheld terminal and/or mobile companion 900 includes a communication subsystem 925 that includes a data communication port 929, which is employed to interface the processor 905 with the network via the host computer. The handheld terminal and/or mobile companion 900 also optionally includes an RF section 990 connected to the processor 905. The RF section 990 includes an RF receiver 995, which receives RF transmissions from the network for example via an antenna 991 and demodulates the signal to obtain digital information modulated therein. The RF section 990 also includes an RF transmitter 996 for transmitting information to a computer on the network, for example, in response to an operator input at a operator input device 950 (e.g., keypad, touch screen) or the completion of a transaction. Peripheral devices, such as a printer 955, signature pad 960, magnetic strip reader 965, and data capture device 992 can also be coupled to the handheld terminal and/or mobile companion 900 through the processor 905. The handheld terminal and/or mobile companion 900 can also include a tamper resistant grid 995 to provide for secure payment transactions. If the handheld terminal and/or mobile companion 900 is employed as payment terminal, it can be loaded with a special operating system. Moreover, if the handheld terminal and/or mobile companion 900 is employed as a general purpose terminal, it can be loaded with a general purpose operating system.

Although the invention has been shown and described with respect to certain illustrated aspects, it will be appreciated that equivalent alterations and modifications will occur to others skilled in the art upon the reading and understanding of this specification and the annexed drawings. In particular regard to the various functions performed by the above described components (assemblies, devices, circuits, systems, etc.), the terms (including a reference to a “means”) used to describe such components are intended to correspond, unless otherwise indicated, to any component which performs the specified function of the described component (e.g., that is functionally equivalent), even though not structurally equivalent to the disclosed structure, which performs the function in the herein illustrated exemplary aspects of the invention. In this regard, it will also be recognized that the invention includes a system as well as a computer-readable medium having computer-executable instructions for performing the acts and/or events of the various methods of the invention.

What is claimed is:

1. A keypad assembly comprising:
a plurality of keys with a surface contour change from a key to another key, the surface contour change based on a location of the key in a geometric locus of movement for a striking finger.

2. The keypad assembly of claim 1, the surface contour change comprises a change of slope on a key surface from one key to another key.

3. The keypad assembly of claim 1, the surface contour change comprises a change of curvature on a key surface from one key to another key.

4. The keypad assembly of claim 1, the geometric locus is an arc and the striking finger is a thumb of a user.

5. The keypad assembly of claim 4, the surface contour changes from a horizontal plane at one end of the arc to a vertical plane at another end of the arc.

6. The keypad assembly of claim 1, the surface contour changes from one key to another key to maximize a contact area with the striking finger.

7. The keypad assembly of claim 1, the surface contour changes from one key to another key to create a substantially perpendicular contact force with the striking finger.

8. The keypad assembly of claim 1 further comprising a raised protrusion on the surface of the keypad to improve a grip of a host device.

9. The keypad assembly of claim 1 further comprising a pillowed key with a recess at a center and raised edges.

10. The keypad assembly of claim 1 further comprising a tactile bump on a key, a location of the tactile bump on the key supplies a cognitive correspondence to a function of the key.

11. The keypad of claim 10, the location signifies a direction of movement of a cursor on a display of a host device.

12. The keypad of claim 10, further comprising a key with sculpted feature(s) memorizable by the user.

13. The keypad of claim 1 further comprising:
a top cover placed over a stack of keypad components; and
a bottom cover placed under the stack; the top cover and the bottom cover over molded around the stack to form a self contained key pad unit.

14. The keypad assembly of claim 13, the stack comprises a printed circuit board with a flex member, an electro luminous panel, a silicone membrane with a plurality of keys, placed on top of each other.

15. A method of fabricating a keypad assembly comprising:
determining a geometric locus for movement of a finger on the keypad surface; and
varying surface contours of keys based on a location thereof in the geometric locus.

16. The method of claim 15, the varying act further comprises maximizing a surface contact between the finger and a key.

17. The method of claim 15, the varying act further comprises forming a substantially perpendicular contact force between the finger and the key.

18. The method of claim 15 further comprising providing a raised protrusion on a surface of the keypad, the raised protrusion elongated on an edge of the keypad.

19. The method of claim 15 further comprising providing a tactile bump on a key, the location of the tactile bump on the key supplies a cognitive correspondence to a function of the key.

20. A keypad assembly comprising:
means for varying angle of surface contact between a user's finger and a key; and
means for providing cognitive correspondence to a user for a key function.
